(19) United States
(12) Patent Application Publication
(10) Pub. No.: US 2005/0105916 A1
(43) Pub. Date: May 19, 2005

(54) Optical transmitter for generating duobinary CSRZ and CSRZ-DPSK optical signals for use in optical communication system

(76) Inventors: Dong Soo Lee, Daejeon (KR); Man Seop Lee, Daejeon (KR); Sang Soo Lee, Daejeon (KR); Je Soo Ko, Daejeon (KR)

Correspondence Address: PIPER RUDNICK LLP, P. O. BOX 9271, RESTON, VA, 20195, US

(21) Appl. No.: 10/972,145

(22) Filed: Oct. 25, 2004

(30) Foreign Application Priority Data
Oct. 24, 2003 (KR) 10-2003-0074746

(51) Int. Cl. H04B 10/04; H04B 10/12

(52) U.S. Cl. 398/182

(57) ABSTRACT

The present invention relates to an optical transmitter for generating a duobinary Carrier Suppressed Return-to-Zero (CSRZ) optical signal and a CSRZ-Differential Phase Shift Keying (DPSK) optical signal for use in an optical communication system. The optical transmitter includes a data encoder, an electric mixer and a single Mach-Zehnder interferometer type external, and is capable of reducing the optical spectrum bandwidth of the optical signal using electrical band limiting and reducing the optical signal distortion caused by Group Velocity Dispersion (GVD) in an optical fiber.

### FIELD OF THE INVENTION

The present invention relates generally to an optical transmitter used in the optical Internet and a large-capacity optical transmission system to convert electric signals into optical signals; and more particularly, to an optical transmitter capable of generating a duobinary Carrier Suppressed Return-to-Zero (CSRZ) optical signal and a Carrier Suppressed Return-to-Zero-Differential Phase Shift Keying (CSRZ-DPSK) optical signal having a considerably reduced spectrum bandwidth of the optical signal, and a reduced distortion of the optical signal caused by group velocity dispersion (GVD) in an optical fiber.

### BACKGROUND OF THE INVENTION

The development of high-speed, large-capacity and long-distance optical transmission systems required by the optical Internet and large-capacity optical transmission systems has been limited by signal distortion in an optical fiber caused by an increase in the data bit rate per channel. In particular, if a data bit rate per channel increases by a multiple of four, signal distortion in an optical fiber increases by more than a multiple of four due to the increase of a required Optical Signal to Noise Ratio (OSNR) and signal distortions caused by Group Velocity Dispersion (GVD), Polarization Mode Dispersion (PMD) and fiber nonlinear effects. The increase of such signal distortion limits the transmission distance in a conventional optical transmission system, thus requiring the change of the construction of a conventional optical network.

In order to reduce the above-described signal distortion in optical fibers for the purpose of increasing the transmission performance of the optical signals, research into modulation formats different from conventional Non Return-to-Zero (NRZ) has been conducted. The conventional NRZ has been used in most optical transmitters because it is advantageous in that manufacturing costs are low due to the simple construction thereof. However, the conventional NRZ is problematic in that it is vulnerable to signal distortion caused by PMD and the nonlinear phenomenon of an optical fiber at a high bit rate. In contrast, Return-to-Zero (RZ) is advantageous in that sensitivity in a receiver is excellent, a clock signal is simply extracted and signal distortion caused by a nonlinear phenomenon in an optical link is small in comparison with NRZ, but is problematic in that it is vulnerable to GVD because of its wide spectrum bandwidth.

Meanwhile, research results showing improvement in transmission characteristics as well as a reduction in the spectrum bandwidth of an optical signal using Carrier Suppressed Return-to-Zero (CS-RZ) modulation format has been reported. The CSRZ is advantageous in that long-distance transmission can be performed because a CSRZ signal is robust against the nonlinear phenomenon of the optical fiber, and more transmission channels can be formed within an available wavelength region because the CSRZ signal has an optical spectrum bandwidth narrower than that of the conventional RZ signal. Furthermore, unlike the NRZ or RZ, optical power at the center wavelength of the optical signal is suppressed, and the phases of the adjacent pulses of the generated optical signal are inverted, so that the CSRZ is advantageous in that Intersymbol Interference (ISI) is reduced, thus improving the transmission performance of the optical signal.

Furthermore, the other modulation format using such CSRZ optical signal includes duobinary CSRZ modulation format and CSRZ-Differential Phase Shift Keying (DPSK) modulation format. The duobinary CSRZ is advantageous in that cross talk is small between channels in a Dense Wavelength Division Multiplexing (DWDM) transmission system because a CSRZ optical signal has an optical spectrum bandwidth narrower than those of other RZ signals, and dispersion characteristics at a receiving end can be improved by using a duobinary optical signal. Furthermore, of the research results reported recently, the CSRZ-DPSK is modulation format used in an optical system that has first transmitted a 40 Gbit/s high-speed optical signal over 10,000 km, thus reducing the nonlinear phenomenon of the optical fiber.

The optical transmitter for generating the above-described duobinary CSRZ and CSRZ-DPSK optical signals is generally formed of two external modulators. A first modulator converts an electric data signal into an optical signal, and a second modulator generates the successive pulses of a carrier suppressed optical signal. Accordingly, the finally output optical signal becomes the duobinary CSRZ optical signal or the CSRZ-DPSK optical signal appropriately modulated from each input optical data signal.

FIG. 1A is a block diagram showing a conventional optical transmitter for generating a duobinary CSRZ optical signal. As shown in FIG. 1A, an input binary data signal is modulated into a duobinary signal sequentially passing through a differential encoder 101 and a duobinary encoder 100, wherein the differential encoder 101 is formed of an “Exclusive OR” logic device EXOR and a one-bit delayer T. The duobinary signal is input to a first Mach-Zehnder interferometer type external modulator 102 after passing through a first amplitude adjuster 103. The first external modulator 102, which is biased to a portion A of the transmission function of the modulator as shown in FIG. 2, modulates an optical signal provided from a semiconductor laser 107 using the duobinary signal to generates an optical duobinary signal. And then, a second Mach-Zehnder interferometer type external modulator 104 generates the successive pulses of a carrier suppressed optical signal through the use of a clock signal CLK from a second amplitude adjuster 105, wherein the clock signal is synchronized with the duobinary signal input to the first external modulator 102 and has a frequency corresponding to ½ of a data bit rate. In this case, the second external modulator 104 is biased to a portion “A” of the transmission function of the modulator as shown in FIG. 2.

FIG. 1B is a block diagram showing a conventional optical transmitter for generating a CSRZ-DPSK optical signal. In FIGS. 1A and 1B, the same reference numerals refer to the same components. As shown in FIG. 1B, an input binary data signal is modulated into a differential signal by a differential encoder formed of an “Exclusive OR” logic device EXOR and a one-bit delayer T. The differential signal is then input to a phase modulator 106 through a first amplitude adjuster 109. The phase modulator 106 modulates the phase of an optical signal provided from the semiconductor laser 107 using the output of the first amplitude adjuster 109, and generates a DPSK optical signal. A Mach-Zehnder interferometer type external modulator 108 generates the successive pulses of the carrier suppressed optical signal through the use of a clock signal CLK from a second amplitude adjuster 111, wherein the clock signal CLK is synchronized with the differential signal provided to the phase modulator 106 and has a frequency corresponding to ½ of a data bit rate. In this case, the external modulator 108 is biased to a portion “A” of the transmission function of the modulator as shown in FIG. 2.

The optical power of the duobinary CSRZ optical signal and the CSRZ-DPSK optical signal using the above-described scheme are suppressed at the center wavelength of the optical signals, and the phases between the adjacent pulses of the generated optical signals are inverted, so that the duobinary CSRZ and CSRZ-DPSK optical signals are advantageous in that ISI is reduced and the transmission performance of the optical signal is improved, but has relatively weak characteristics in optical fiber dispersion, thus making the design and management of an optical link difficult.

Furthermore, each of the conventional optical transmitters shown in FIGS. 1A and 1B uses two external modulators to generate the duobinary CSRZ and CSRZ-DPSK optical signals; so that it is problematic in that the two external modulators cause an increase in the manufacturing costs of the optical transmitter because the external modulators are the most expensive components of the optical transmitters.

### SUMMARY OF THE INVENTION

It is, therefore, an object of the present invention to provide an optical transmitter capable of generating a duobinary CSRZ optical signal and a CSRZ-DPSK optical signal having a reduced spectrum bandwidth of the optical signal by using a single Mach-Zehnder interferometer type external modulator.

In accordance with the present invention, an optical transmitter for generating an optical modulated signal for use in an optical communication system comprises: a data encoder for encoding an input binary data signal; a mixer for mixing the encoded binary data signal from the data encoder with a clock signal in an electric domain to produce a mixed data signal; and a Mach-Zehnder interferometer type external modulator for modulating an optical signal using the mixed data signal from the mixer to produce the optical modulated signal.

The mixer adjusts the mixed signal to be ac-coupled and to swing around zero voltage.

The clock signal has a frequency corresponding to ½ of a bit rate of the input binary data signal, and synchronizes with the encoded data signal provided by the data encoder.

The optical transmitter further includes: a low band-pass filter for performing the band limiting on the mixed signal provided by the mixer, to thereby allow the optical modulated signal to have a narrow optical spectrum; and an amplitude adjuster for adjusting the mixed signal having passed through the low band-pass filter to swing to +V_{π} or −V_{π} around zero voltage.

The low band-pass filter has a bandwidth that is adjusted to maximize dispersion tolerance and to minimize intersymbol interference (ISI) caused by the low band-pass filter in the optical modulated signal.

The data encoder includes a duobinary encoder for converting the input binary data signal into a duobinary signal and for adjusting the duobinary signal to symmetrically swing around zero voltage, wherein the Mach-Zehnder interferometer type external modulator performs push-pull operation and has a low chirp characteristic, to thereby generate a duobinary CSRZ optical signal as the optical modulated signal.

Further, the data encoder includes a differential encoder for converting the input binary data signal into a differential signal and for adjusting the differential signal to symmetrically swing around zero voltage, wherein the Mach-Zehnder interferometer type external modulator performs push-pull operation and has a low chirp characteristic, to thereby generate a CSRZ-DPSK optical signal as the optical modulated signal.

### BRIEF DESCRIPTION OF THE DRAWINGS

The above and other objects and features of the present invention will become apparent from the following description of preferred embodiments given in conjunction with the accompanying drawings, in which:

FIGS. 1A and 1B are block diagrams of a conventional optical transmitter for generating duobinary CSRZ and CSRZ-DPSK optical signals;

FIG. 2 is a view showing an example of an operational characteristic of a Mach-Zehnder interferometer type external modulator;

FIG. 3 is a block diagram showing the arrangement of an optical transmitter for generating duobinary CSRZ and CSRZ-DPSK optical signals according to an embodiment of the present invention;

FIGS. 4A and 4B are detailed block diagrams showing the data encoder shown in FIG. 3;

FIGS. 5A to 5E are waveform diagrams of the driving signals of an optical modulator for generating the duobinary CSRZ optical signal in the optical transmitter;

FIGS. 5F to 5J are waveform diagrams of the driving signals of the optical transmitter for generating the CSRZ-DPSK optical signal in the optical transmitter; and

FIGS. 6A and 6B are graphs showing examples of the spectra of the duobinary CSRZ and CSRZ-DPSK optical signals generated by the optical transmitter shown in FIG. 3; and

FIGS. 7A and 7B are graphs showing examples of eye opening penalty (EOP) according to the residual dispersion of the duobinary CSRZ and CSRZ-DPSK optical signal generated by the optical transmitter shown in FIG. 3.

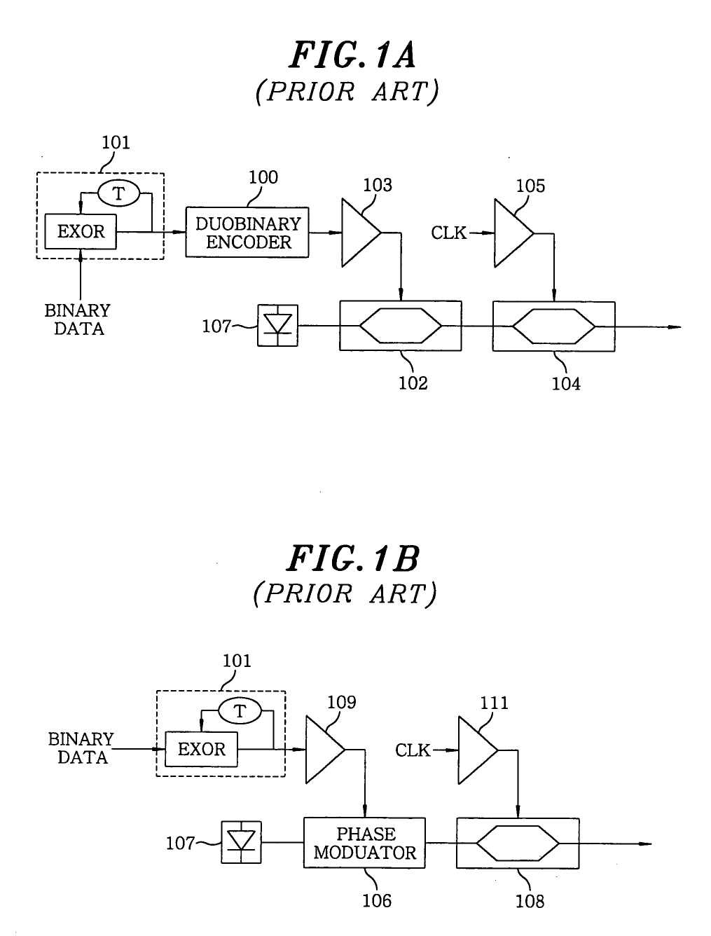

### DETAILED DESCRIPTION OF THE PREFERRED EMBODIMENTS

A preferred embodiment of the present invention will be described in detail with reference to the attached drawings below.

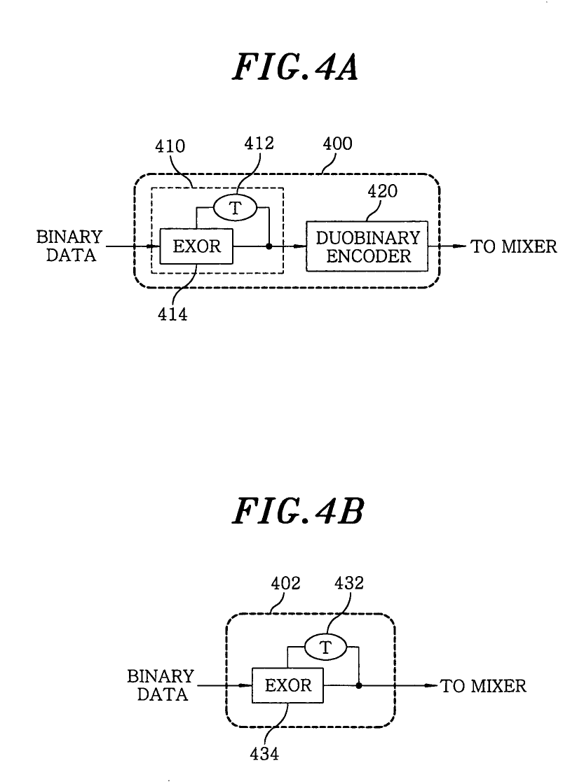

FIG. 3 is a block diagram showing an optical transmitter for generating duobinary CSRZ and CSRZ-DPSK optical signals according to an embodiment of the present invention. As shown in FIG. 3, the optical transmitter of the present invention includes a data encoder 300 for modulating an input binary data signal, an electric mixer 302 for mixing the output signal of the data encoder 300 with an electric clock signal in an electric domain, a low band-pass filter 304 for admitting only low frequency bands for the mixed signal by the electric mixer 302, an amplitude adjuster 306 for adjusting the mixed signal, and a Mach-Zehnder interferometer type external modulator 308 for modulating an optical signal from an external optical source 307, such as a semiconductor laser, through the use of the mixed signal.

Unlike the conventional scheme in which two electric signals, that is, a binary data signal and a clock signal, are mixed together in an optical domain using two external modulators to generate an optical modulated signal, the embodiment of the present invention is characterized in that two signals are mixed first in an electric domain and then converted into an optical modulated signal using an external modulator. Accordingly, it is possible to generate the optical modulated signal using a single external modulator instead of two external modulators. Furthermore, the present invention performs band limiting on an electrically mixed signal using the low band-pass filter, thus considerably reducing the spectrum bandwidth of the optical modulated signal.

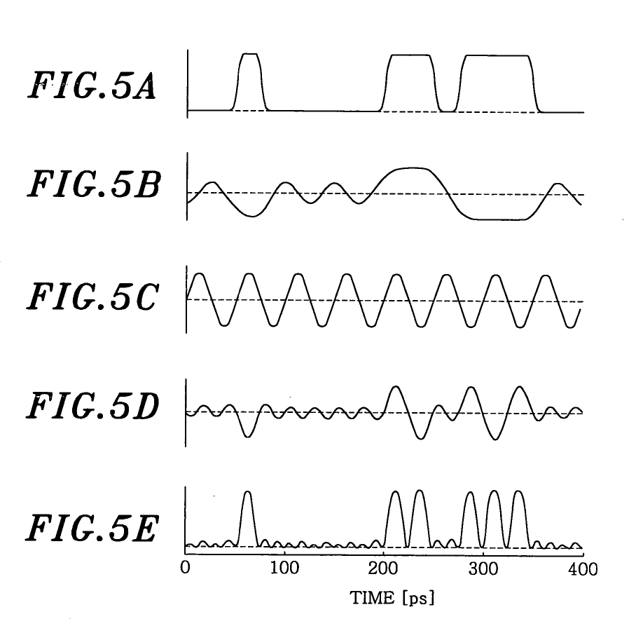

The data encoder 300 serves to encode an input binary data signal. The detailed construction of the data encoder will be described with reference to FIGS. 4A and 4B.

The electric mixer 302 functions to generate a mixed data signal by mixing an electric data signal with an electric clock signal and adjusts the mixed data signal to be ac-coupled and to swing around zero voltage.

In this case, the electric data signal is the binary data signal encoded by the data encoder 300, and the electrical clock signal has a frequency that corresponds to ½ of the bit rate of the binary data signal input to the data encoder 300 and synchronizes with the binary data signal modulated by the data encoder 300.

The low band-pass filter 304 allows the optical signal to be generated by the optical transmitter of the present invention to have a narrow optical spectrum by performing band limiting on the mixed data signal provided by the electric mixer 302. The bandwidth of the low band-pass filter 304 is adjusted in such a way as to maximize the dispersion tolerance of the optical signal from the optical transmitter of the present invention while minimizing the distortion of the optical signal from the optical transmitter of the present invention. In the present invention, the low band-pass filter includes not only an independent low band-pass filter 304 shown in FIG. 3 but also all the components having the low band-pass filter's characteristics incorporated in the mixer, the amplitude adjuster, the external modulator and the transmission path of the electric signal.

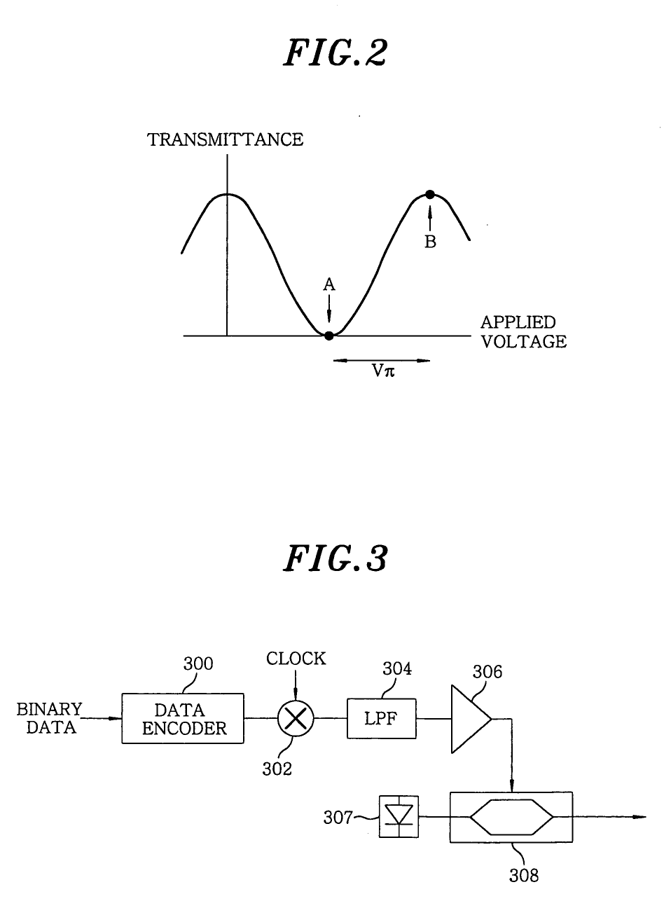

The amplitude adjuster 306 adjusts the mixed data signal provided by the electric mixer 302 to swing to +V_{π} or −V_{π} around zero voltage, and transmits the adjusted data signal to the Mach-Zehnder interferometer type external modulator 308. In this case, the V_{π} refers to the difference between voltage values when the magnitudes of the optical signal output from the Mach-Zehnder interferometer type external modulator 308 become maximized (referred to as the point “B” of FIG. 2) and minimized (referred to as the point “A” of FIG. 2), respectively.

The Mach-Zehnder interferometer type external modulator 308 modulates an optical signal provided from a semiconductor laser 307 using the adjusted data signal from the amplitude adjuster 306 to produce a duobinary optical signal. The Mach-Zehnder interferometer type external modulator 308 performs push-pull operation and has a low chirp characteristic.

Referring to FIG. 4A, there is shown a duobinary encoder 400 which is used as the data encoder 300. The duobinary encoder 400 allows the optical transmitter of the present invention to generate a duobinary CSRZ optical signal as the output from the optical transmitter. The duobinary encoder 400 shown in FIG. 4A includes a differential encoder 410 for converting the input binary data signal into a differential binary signal and a duobinary filter 420 for filtering the differential binary signal from the differential encoder 402 to produce the duobinary data signal, wherein the differential encoder 410 has a one-bit delayer 412 for delaying the encoded binary data signal by one bit and an “Exclusive OR” logic device 414 for performing a logical “Exclusive OR” operation on the input binary data signal and the encoded binary data signal delayed by one bit by the one-bit delayer 412. The duobinary data signal is then provided to the electric mixer 302 as the encoded binary data signal from the data encoder 300.

On the other hand, referring to FIG. 4B, there is shown a differential encoder 402 which is used as the data encoder 300. The differential encoder 402 allows the optical transmitter of the present invention to generate a CSRZ-DPSK optical signal.

The differential encoder 402 shown in FIG. 4B encodes the input binary data signal to produce a differential data signal and includes a one-bit delayer 432 for delaying the encoded binary data signal by one bit, and an “Exclusive OR” logic device 434 for performing a logical “Exclusive OR” operation on the input binary data signal and the encoded binary data signal delayed by one bit by the one-bit delayer 412. The differential data signal is then provided to the electric mixer 302 as the encoded binary data signal from the data encoder 300.

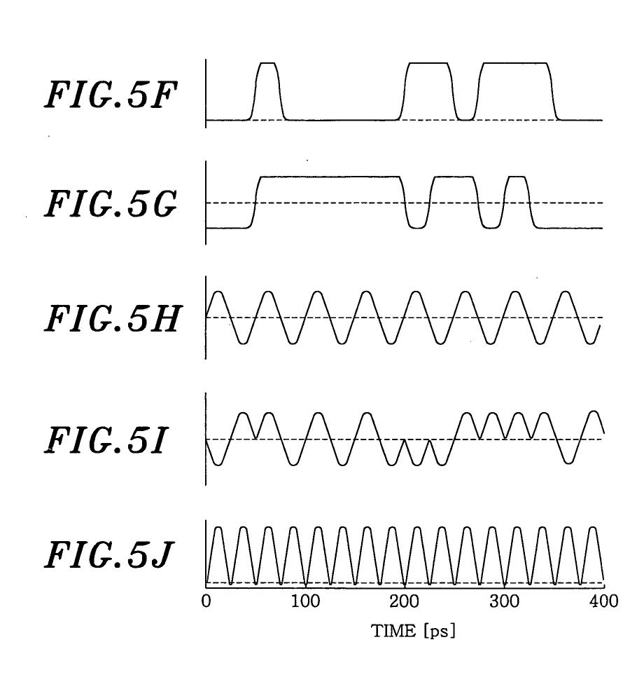

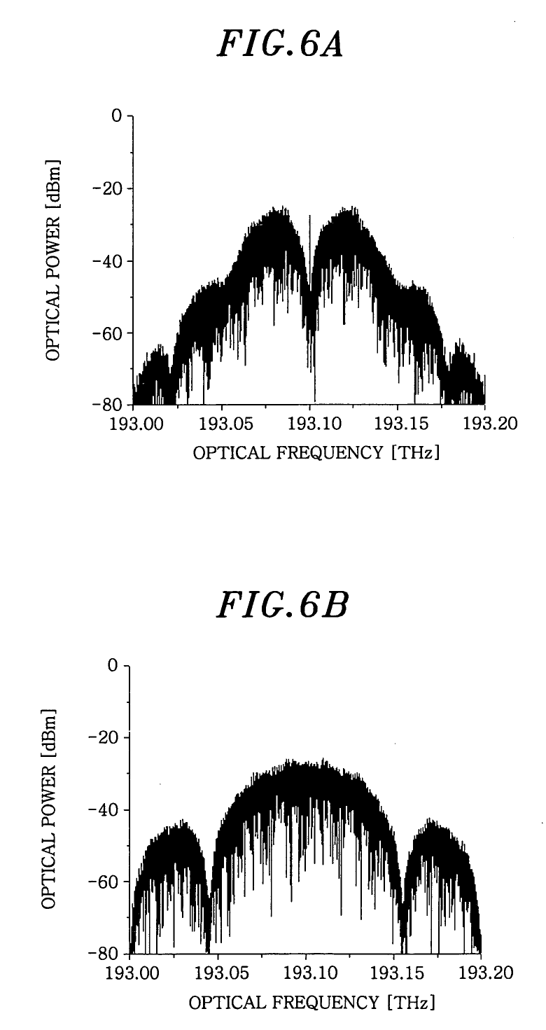

FIG. 5A to FIG. 5E are views showing the variations of signal waveforms while a duobinary CSRZ optical signal is generated by a 40 Gbit/s input binary data signal in the optical transmitter of the present invention. FIG. 5A shows a binary data signal input to the optical transmitter of the present invention, and FIG. 5B shows a duobinary data signal modulated by the duobinary encoder 400, that is, the data encoder 300. FIG. 5C shows a clock signal input to the electric mixer 302. FIG. 5D shows a mixed data signal obtained by mixing two electric data and clock signals of FIG. 5B and FIG. 5C together. Furthermore, FIG. 5E shows a duobinary CSRZ optical signal modulated by the Mach-Zehnder interferometer type external modulator 308. The optical spectrum of the duobinary CSRZ optical signal generated according to the present invention is shown in FIG. 6A.

On the other hand, FIG. 5F to FIG. 5J are views showing the variations of signal waveforms while a CSRZ-DPSK optical signal is generated by a 40 Gbit/s input binary data signal in the optical transmitter of the present invention. FIG. 5F shows a binary data signal input to the optical transmitter of the present invention, and FIG. 5G shows a differential signal modulated by the differential encoder 402, that is, the data encoder 300. FIG. 5H shows a clock signal input to the electric mixer 302. FIG. 5I shows a mixed data signal obtained by mixing two electric signals of FIG. 5G and FIG. 5H together. Furthermore, FIG. 5J shows a CSRZ-DPSK optical signal modulated by the Mach-Zehnder interferometer type external modulator 308. The optical spectrum of the CSRZ-DPSK optical signal generated according to the present invention is shown in FIG. 6B.

Accordingly, the optical transmitter for generating the duobinary CSRZ optical signal and the CSRZ-DPSK optical signal according to the present invention can be cost effectively constructed using a single external modulator compared to a conventional optical transmitter that uses two external modulators. Furthermore, the spectrum bandwidth of the generated optical signal is reduced by electrical band limiting, so that the optical transmitter of the present invention is advantageous in that signal distortion due to the dispersion of an optical fiber is reduced.

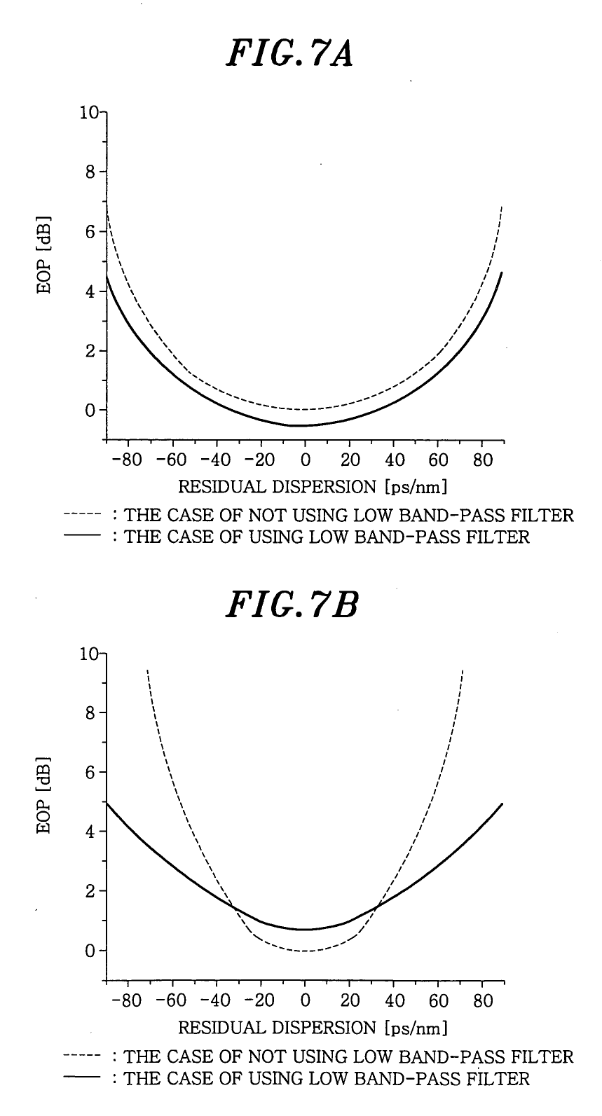

FIGS. 7A and 7B are graphs showing the dispersion tolerance of the duobinary CSRZ optical signal and the CSRZ-DPSK optical signal generated by the optical transmitter according to the embodiment of the present invention. In the above description of the present invention, an ideal mixer was used to understand the dispersion tolerance of the duobinary CSRZ and the CSRZ-DPSK optical signals according to the embodiment of the present invention, and a fourth-order Bessel filter was used as the low band-pass filter. Furthermore, the low band-pass filter characteristics in the above-mentioned components other than the low band-pass filter were not considered. Furthermore, it was assumed that the bit rate of the input binary data was 40 Gbit/s, and the case where the bandwidth of the low band-pass filter used was assumed to be 24 GHz was compared with the case where the low band-pass filter did not exist. Signal distortion is evaluated using eye opening penalty (EOP), and it is observed that the signal distortion increases in proportion to EOP.

FIG. 7A is a graph showing the distortion characteristic of the duobinary CSRZ optical signal generated by the optical transmitter of the present invention. From FIG. 7A, it can be understood that the signal distortion due to dispersion in the case where the low band-pass filter is used is smaller than that in the case where the low band-pass filter is not used. The reason for this is that the spectrum bandwidth of the optical signal is reduced by the low band-pass filter. Furthermore, if the bandwidth of the low band-pass filter is reduced, the ISI of the duobinary CSRZ optical signal is suppressed by the low band-pass filter, thus improving EOP. Accordingly, EOP in the case where the low band-pass filter is used and dispersion is zero is relatively lower than the case where the low band-pass filter is not used. However, if the bandwidth of the low band-pass filter is reduced more, performance is reduced due to signal distortion caused by the low band-pass filter, thus increasing the EOP. Accordingly, the bandwidth of the low band-pass filter for the duobinary CSRZ optical signal generated by the optical transmitter of the present invention must be optimally adjusted in consideration of the signal distortion and the dispersion tolerance of the optical signal.

FIG. 7B is a graph showing the dispersion tolerance of the CSRZ-DPSK optical signal generated by the optical transmitter of the present invention. From FIG. 7B, it can be understood that the signal distortion due to dispersion in the case where the low band-pass filter is used is smaller than that in the case where the low band-pass filter is not used. The reason for this is that the spectrum bandwidth of the optical signal is reduced by the low band-pass filter. However, if the bandwidth of the low band-pass filter is reduced, performance is reduced due to signal distortion caused by the low band-pass filter, so that EOP in the case where the low band-pass filter is used and dispersion is zero is considerably larger than the case where the low band-pass filter is not used. Accordingly, the bandwidth of the low band-pass filter for the CSRZ-DPSK optical signal generated by the optical transmitter of the present invention must be optimally adjusted in consideration of the signal distortion and the dispersion tolerance of the optical signal.

As described above, the optical transmitter for generating a duobinary CSRZ optical signal and a CSRZ-DPSK optical signal according to the present invention is implemented using a single external modulator, unlike the conventional optical transmitter that uses two external modulators, so that the present invention is advantageous in that the optical transmitter is inexpensively implemented, compared with the conventional optical transmitter. Furthermore, the present invention is advantageous in that the optical spectrum bandwidth of the optical signal generated by the optical transmitter of the present invention is reduced using electrical band limiting, and the optical signal distortion due to GVD in an optical fiber is reduced.

Meanwhile, although the detailed embodiment of the present invention is described above, various modifications may be implemented without departing from the scope of the present invention. Accordingly, the scope of the present invention is not limited by the above-described embodiment but is determined by claims.

1. An optical transmitter for generating an optical modulated signal for use in an optical communication system, comprising:
a data encoder for encoding an input binary data signal;
a mixer for mixing the encoded binary data signal from the data encoder with a clock signal in an electric domain to produce a mixed data signal; and
a Mach-Zehnder interferometer type external modulator for modulating an optical signal using the mixed data signal to produce the optical modulated signal.

2. The optical transmitter of claim 1, wherein the mixer adjusts the mixed data signal to be ac-coupled and to swing around zero voltage.

3. The optical transmitter of claim 1, wherein the clock signal has a frequency corresponding to ½ of a bit rate of the input binary data signal, and synchronizes with the encoded data signal provided by the data encoder.

4. The optical transmitter of claim 1, wherein the optical transmitter further comprising:
a low band-pass filter for performing the band limiting on the mixed data signal provided by the mixer to thereby allow the optical modulated signal to have a narrow optical spectrum by; and
an amplitude adjuster for adjusting the mixed data signal having passed through the low band-pass filter to swing to +V_{π} or −V_{π} around zero voltage, wherein the mixed data signal having passed through the amplitude adjuster is provided to the Mach-Zehnder interferometer type external modulator.

5. The optical transmitter of claim 4, wherein the low band-pass filter has a bandwidth that is adjusted to maximize dispersion tolerance and to minimize intersymbol interference (ISI) caused by the low band-pass filter in the optical modulated signal.

6. The optical transmitter of claim 5, wherein the data encoder comprises:
a duobinary encoder for modulating the input binary data signal to produce a duobinary data signal as the encoded binary data signal and for adjusting the duobinary data signal to symmetrically swing around zero voltage for generating a duobinary CSRZ optical signal.

7. The optical transmitter of claim 5, wherein the data encoder comprises:
a differential encoder for converting the input binary data signal into a differential signal as the encoded binary data signal and for adjusting the differential signal to symmetrically swing around zero voltage for generating a CSRZ-DPSK optical signal.

8. The optical transmitter of claim 6, wherein the Mach-Zehnder interferometer type external modulator performs push-pull operation and has a low chirp characteristic, to thereby generate the duobinary CSRZ optical signal as the optical modulated signal.

9. The optical transmitter of claim 7, wherein the Mach-Zehnder interferometer type external modulator performs push-pull operation and has a low chirp characteristic, to thereby generate the CSRS-DPSK optical signal as the optical modulated signal.
